(19) United States
(12) Patent Application Publication
(10) Pub. No.: US 2007/0268238 A1
(43) Pub. Date: Nov. 22, 2007

(54) Image-displaying control circuit of a scan-backlight LCD

(75) Inventors: Shu-Ming Chang, Hsinhua (TW); Yu-Pei Huang, Hsinhua (TW); Shen-Yao Liang, Hsinhua (TW); Shwang-Shi Bai, Hsinhua (TW); Ying-Chou Tu, Hsinhua (TW)

Correspondence Address: THE WEBB LAW FIRM, P.C., 700 KOPPERS BUILDING, 436 SEVENTH AVENUE, PITTSBURGH, PA, 15219, US

(73) Assignee: HIMAX TECHNOLOGIES, INC., Hsinhua (TW)

(21) Appl. No.: 11/438,805

(22) Filed: May 22, 2006

(51) Int. Cl. G09G 3/36

(52) U.S. Cl. 345/102

(57) ABSTRACT

An image-displaying control circuit used in a scan-backlight LCD is disclosed. The image-displaying control circuit comprises a driver control circuit, a plurality of gate driver groups, a backlight control circuit and a plurality of backlight driver groups. Each of the gate driver groups is used to drive one of the display blocks, and the driver control circuit outputs a gate sequence signal to the gate driver groups. The gate drive groups can respectively drive the display blocks in a driving sequence according to the gate sequence signal. The backlight driver groups controlled by the backlight control circuit are respectively used to turn on one of the backlight blocks, and the driver control circuit outputs a backlight sequence signal to the backlight control circuit. Then, the backlight control circuit can control the backlight driver groups to respectively turn on the backlight blocks in the same driving sequence as the display blocks.

### BACKGROUND

1. Field of Invention

The present invention relates to a liquid crystal display (LCD). More particularly, the present invention relates to a scan-backlight LCD in which the displaying sequence of the display blocks in the LCD can be adjusted.

2. Description of Related Art

With progress in the flat panel display (FPD) industry, there has been a tendency for consumers to shift from conventional cathode-ray tube (CRT) displays to liquid crystal displays (LCD) because LCDs have smaller volumes, lighter weights, lower radiation and lower power consumption. Nowadays, LCD panels are commercially used in consumer products, such as personal digital assistants (PDA), mobile phones, cameras, laptops and televisions.

FIG. 1 shows a display framework 100 of a conventional LCD, which comprises a backlight module 108 and a pixel array 102 used to display images. In general, a scan-backlight control mode is used to improve the quality of video images. In the scan-backlight control mode, the pixel array 102 is separated into several display blocks, that is, display blocks 102a-102d shown in FIG. 1. Likewise, the backlight module 108 is also separated into several backlight blocks corresponding to the display blocks in location, that is, backlight blocks 108a-108d shown in FIG. 1. The display blocks 102a-102d are respectively driven by gate driver groups 106a-106d and charged by a data driver 104. Backlight driver groups 110a-110d are respectively used to turn on or turn off the backlight blocks 108a-108d.

The data driver 104 and the gate driver groups 106a-106d are controlled by a driver control circuit 112. The backlight driver groups 110a-110d are controlled by a backlight control circuit 114. In the scan-backlight control mode, the driver control circuit 112 controls the gate driver groups 106a-106d and the data driver 104 to respectively drive and charge the display blocks 102a-102d in a fixed sequence from the display block 102a to the display block 102d. The driver control circuit 112 controls the gate driver groups 106a-106d via a control signal 120 for driving the display blocks 102a-102d in order from display block 102a to display block 102d in the same sequence to display a complete image. Therefore, the backlight control circuit 114 should be synchronized with the driver control circuit 112 via a synchronization signal 122 outputted from the driver control circuit 112. Then, the backlight control circuit 114 uses a clock signal 124 to control the backlight driver groups 110a-110d to turn on the backlight blocks 108a-108d in the fixed sequence, and uses a delay signal 126 to set the turning-on period of each of the backlight blocks 108a-108d.

Due to the response time of the liquid crystal in the LCD being slow, a liquid crystal charging period is needed to charge a display block to the desired level. When the backlight block corresponding to the display block is turned on within the liquid crystal charging period, an undesired image is displayed. Therefore, the backlight block should be turned on after the display block that it corresponds to is charged to the desired level.

According to the foregoing principle, FIG. 2 shows the turning-on and turning-off status of each of the backlight blocks 108a-108d when the images are continuously displayed. Between the clock cycles 1-4, the display blocks 102a-102d are charged once according to a fixed sequence, and the clock cycles 1-4 can be seen as an image cycle. Similarly, the clock cycles 5-8 and 9-12 can also be seen as an image cycle respectively. Assuming that the liquid crystal charging period of the display block is two clock cycles, when the display block 102a is charged in the clock cycle 1, the backlight block 108a corresponding to the display block 102a waits for the clock cycle 3 to be turned on to display part of the first image. In clock cycle 5, the backlight block 108a waits again for clock cycle 7, at which time the display block 102a is charged again. Similarly, the backlight block 108b corresponding to the display block 102b is turned on during clock cycles 4 and 5. The backlight block 108c corresponding to the display block 102c is turned on during clock cycles 5 and 6. The backlight block 108d corresponding to the display block 102d is turned on during clock cycles 6 and 7.

According to the foregoing description with regard to the scan-backlight control mode, the backlight module in a conventional LCD is separated into several backlight blocks, and the backlight blocks are turned on and off in accordance with the sequence which is used to charge the display blocks of the pixel array in the LCD. However, the backlight blocks should usually be turned on and off in coordination with the image scanning frequency of the LCD, and the image scanning frequency is typically 60˜75 Hz. Thus, LCD images very easily flicker and make users uncomfortable.

### SUMMARY

It is therefore an objective of the present invention to provide a displaying control circuit used in a scan-backlight LCD.

It is another objective of the present invention to provide a displaying control circuit used to improve the quality of video images displayed on a scan-backlight LCD.

It is another objective of the present invention to provide a displaying control circuit used to reduce the flicker of displayed images on a scan-backlight LCD.

It is another objective of the present invention to provide a scan-backlight LCD of which the displaying sequence of the display blocks in the scan-backlight LCD can be adjusted.

To achieve the foregoing and other objectives, the present invention provides an image-displaying control circuit used in an LCD for driving display blocks of the pixel array and backlight blocks of the backlight module in the LCD. The control circuit comprises a driver control circuit, a plurality of gate driver groups, a backlight control circuit and a plurality of backlight driver groups. Each of the gate driver groups is used to drive one of the display blocks, and the driver control circuit outputs a gate sequence signal to the gate driver groups. Then, each of the gate drive groups can respectively drive the display blocks in a driving sequence according to the gate sequence signal. The backlight driver groups controlled by the backlight control circuit are respectively used to turn on one of the backlight blocks, and the driver control circuit outputs a backlight sequence signal to the backlight control circuit. Then, the backlight control circuit can control the backlight driver groups to respectively turn on the backlight blocks in the same driving sequence as the display blocks. Thus, the driving sequence used to drive the display blocks and turn on the backlight blocks can be optionally adjusted by adjusting the gate sequence signal and the backlight sequence signal to reduce the flicker of displayed images on the LCD.

The gate sequence signal comprises a plurality of bits. In an embodiment of the present invention, the different code formed with the bits represents the different driving sequences. In another embodiment of the present invention, each of the display blocks has its own address code, and the gate sequence signal uses the address code to designate which display block should be turned on.

The backlight sequence signal also comprises a plurality of bits. In an embodiment of the present invention, the different code formed with the bits represents the different driving sequences of the backlight blocks. In another embodiment of the present invention, the backlight sequence signal represents the turning on and turning off time points of each of the backlight blocks.

### BRIEF DESCRIPTION OF THE DRAWINGS

These and other features, aspects and advantages of the present invention will become better understood with regard to the following description, appended claims and accompanying drawings, where:

FIG. 1 is a diagram of a conventional LCD;

FIG. 2 is a status diagram of backlight blocks in a conventional LCD when images are displayed;

FIG. 3 is a status diagram of backlight blocks in the LCD according to an embodiment of the present invention when images are displayed;

FIG. 4 is a diagram of the LCD according to an embodiment of the present invention.

### DESCRIPTION OF THE PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

According to the foregoing discussion, one purpose of the present invention is making the driving sequence of the display blocks and the backlight blocks in a LCD adjustable; thus, the driving sequence of the backlight blocks are not tied to the image scanning frequency of the LCD. The flicker of the LCD can thereby be reduced when images are displayed.

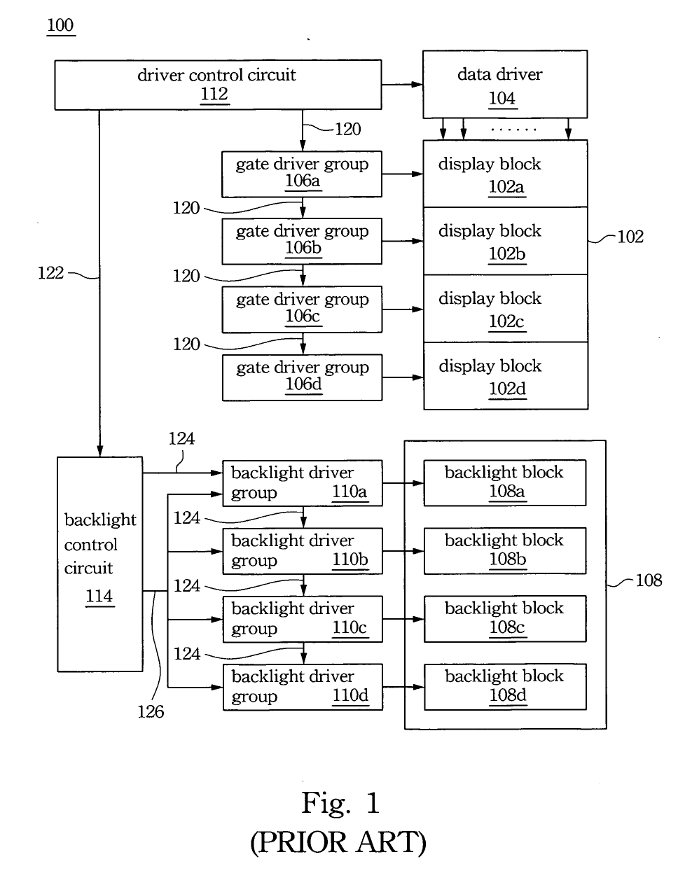

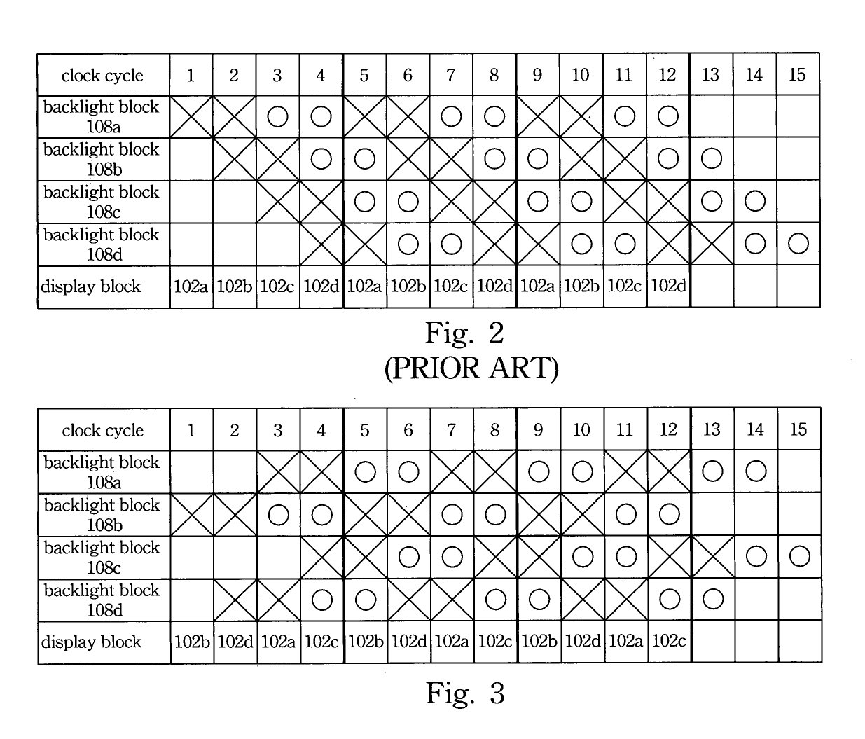

FIG. 3 shows the turning-on and turning-off status of each of the backlight blocks 108a-108d shown in FIG. 1 when the images are continuously displayed. The difference between the status diagrams shown in FIG. 2 and FIG. 3 is that the driving and charging sequence of the display blocks within the image cycles of FIG. 3, such as clock cycles 1-4, 5-8 and 9-12, are display blocks 102b, 102d, 102a and 102c. Comparatively, the turning-on sequence of the backlight blocks is also changed to the backlight blocks 108b, 108d, 108a and 108c. Thus, the turning-on sequence of the backlight blocks 108a-108d are not tied to the image scanning frequency of the LCD.

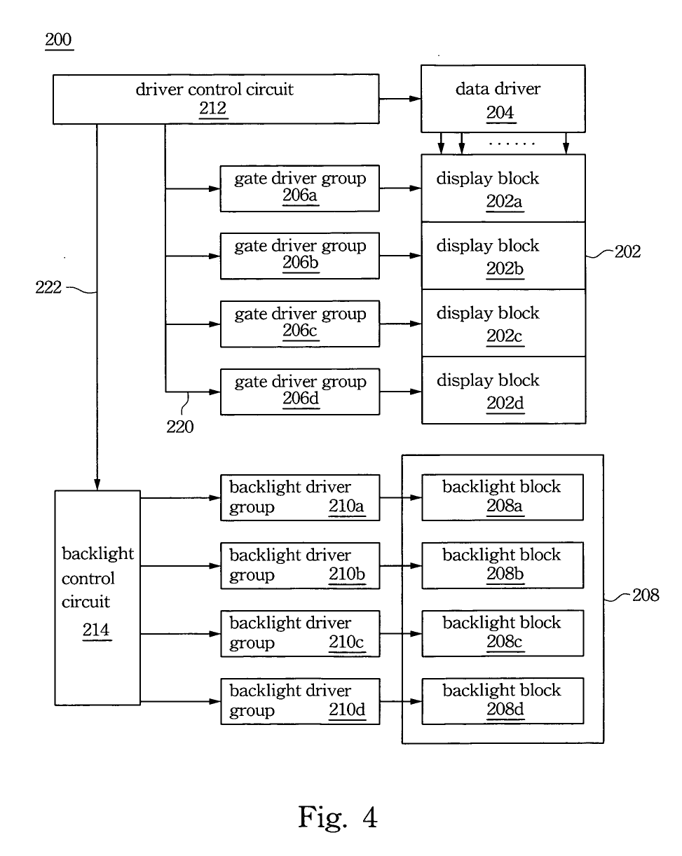

For implementing the foregoing described purpose, the framework of the conventional LCD must be changed. FIG. 4 shows a display framework 200 according to an embodiment of the present invention. The display framework 200 comprises a pixel array 202 used to display images and a backlight module 208. In general, a scan-backlight control mode is usually used to improve the quality of video images. The pixel array 202 is separated into several display blocks, that is, display blocks 202a-202d shown in FIG. 4. Likewise, the backlight module 208 is also separated into several backlight blocks corresponding to the display blocks in position, that is, backlight blocks 208a-208d shown in FIG. 4. The display blocks 202a-202d are respectively driven by gate driver groups 206a-206d and charged by a data driver 204. Backlight driver groups 210a-210d are respectively used to turn on or turn off the backlight blocks 208a-208d.

The data driver 204 and gate driver groups 206a-206d are controlled by a driver control circuit 212. In the scan-backlight control mode, the driver control circuit 212 controls the gate driver groups 206a-206d and the data driver 204 to respectively drive and charge the display blocks 202a-202d in an adjustable driving sequence, wherein the driver control circuit uses a gate sequence signal 220 to control the driving sequence of the display blocks 202a-202d.

In an embodiment of the present invention, the gate sequence signal 220 comprises several bits, and a code formed of the bits represents the driving sequence of the display blocks 202a-202d. For example, the driving sequence of the display blocks 202a-202d has twenty-four variations; therefore, the gate sequence signal 220 should comprise at least five bits, wherein, the code “00001” represents the driving sequence of display blocks 202a, 202b, 202d and 202c, and the code “10011” represents the driving sequence of display blocks 202d, 202c, 202b and 202a. Thus, the gate driver groups 206a-206d and the data driver 204 can drive and charge the display blocks 202a-202d according to the driving sequence represented by the gate sequence signal.

In another embodiment of the present invention, each of the gate driver groups 206a-206d has a unique address code. One of the gate driver groups 206a-206d should operate when its address code appears in the gate sequence signal 220. For example, two bits for each of the display blocks 202a-202d are needed to form the address code of each of the display blocks 202a-202d, such as “00” for the display block 202a, “01” for the display block 202b, “10” for the display block 202c and “11” for the display block 202d. Thus, the gate sequence signal 220 should comprise at least two bits. When the gate sequence signal 220 appears as “00”, the gate driver group 206a drives the display block 202a and then the data driver 204 charges the display block 202a. Similarly, when the gate sequence signal 220 appears as “01”, the gate driver group 206b drives the display block 202b, when the gate sequence signal 220 appears as “10”, the gate driver group 206c drives the display block 202c, and when the gate sequence signal 220 appears as “11”, the gate driver group 206d drives the display block 202d. The driving sequence can be adjusted by altering the appearance sequence of the address code of the gate driver groups 206a-206d in the gate sequence signal 220.

In the LCD scan-backlight control mode, the backlight blocks 208a-208d correspond to the display blocks 202a-202d in position, and the backlight blocks 208a-208d are turned on and off in the driving sequence identical to the display blocks 202a-202d. However, the time point for turning on the backlight blocks 208a-208d may be later than the time point for driving the display blocks 202a-202d by delaying a liquid crystal charging period; therefore, the turning on and off of the backlight blocks 208a-208d must be controlled by a backlight control circuit 214.

The backlight control circuit 214 references a backlight sequence signal 222 outputted from the driver control circuit 212 to determine the driving sequence of the backlight blocks 208a-208d. In an embodiment of the present invention, the backlight sequence signal 222 comprises several bits, and a code formed of the bits represents the driving sequence of the backlight blocks 208a-208d. For example, the driving sequence of the backlight blocks 208a-208d has twenty-four variations; therefore, the backlight sequence signal 222 should comprise at least five bits, wherein, the code “00001” represents the driving sequence of backlight blocks 208a, 208b, 202d and 208c and the code “10011” represents the driving sequence of backlight blocks 208d, 208c, 208b and 208a. Thus, the backlight driver groups 210a-210d can turn on the display blocks 202a-202d according to the driving sequence represented by the backlight sequence signal. Furthermore, the length of the turning on period of each of the backlight blocks may also be represented in the backlight sequence signal.

The information of the turning-on time point and turning-off time point of each of the backlight blocks 208a-208d may also be designated by the backlight sequence signal 222. In another embodiment of the present invention, the backlight sequence signal 222 may comprise at least eight bytes, wherein the first, the third, the fifth and the seventh bytes respectively represent the time points for turning on the backlight blocks 208a-208d, and the second, the fourth, the sixth and the eighth bytes respectively represent the time points for turning off the backlight blocks 208a-208d. Thus, the backlight driver groups 210a-210d can turn on and off the display blocks 202a-202d according to the time points designated by the backlight sequence signal 222.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An image-displaying control circuit comprising:
a plurality of gate driver groups, each of which drives one display block;
a driver control circuit generating a gate sequence signal to control the gate driver groups so that the display blocks are driven in a first sequence, and output a backlight sequence signal;
a plurality of backlight driver groups, each of which turns on and off one of the backlight blocks; and
a backlight control circuit receiving the backlight sequence signal to control the backlight driver groups so that the backlight blocks are turned on in a second sequence corresponding to the first sequence.

2. The image-displaying control circuit as claimed in claim 1, wherein each of the display blocks corresponds to one of the backlight blocks.

3. The image-displaying control circuit as claimed in claim 2, wherein the time point for turning on the backlight blocks is later than the time point for driving the display blocks by a liquid crystal charging period.

4. The image-displaying control circuit as claimed in claim 1, wherein the gate sequence signal comprises several bits, and a code formed of the bits represents the first sequence.

5. The image-displaying control circuit as claimed in claim 1, wherein each of the gate driver groups has an address code, and one of the gate driver groups operates when its address code appears in the gate sequence signal.

6. The image-displaying control circuit as claimed in claim 5, wherein the first sequence of the display blocks is adjusted by altering an appearance sequence of the address code of the gate driver groups in the gate sequence signal.

7. The image-displaying control circuit as claimed in claim 1, wherein the backlight sequence signal comprises several bits, and a code formed of the bits represents the second sequence.

8. The image-displaying control circuit as claimed in claim 7, wherein the backlight sequence signal further represents a period of turning on each of the backlight blocks.

9. The image-displaying control circuit as claimed in claim 1, wherein the backlight sequence signal is used to designate the time point to turn on and the time point to turn off each of the backlight blocks.

10. A scan-backlight liquid crystal display (LCD), comprising:
a pixel array, wherein the pixel array is separated into a plurality of display blocks;
a backlight module, wherein the backlight module is separated into a plurality of backlight blocks;
a plurality of gate driver groups, each of which drives one of the display blocks;
a driver control circuit generating a gate sequence signal to control the gate driver groups so that the display blocks are driven in a first sequence, and outputting a backlight sequence signal;
a data driver charging the display block currently driven by one of the gate driver groups;
a plurality of backlight driver groups, each of which turns on and off one of the backlight blocks; and
a backlight control circuit receiving the backlight sequence signal to control the backlight driver groups so that the backlight blocks are turned on in a second sequence corresponding to the first sequence.

11. The scan-backlight LCD as claimed in claim 9, wherein each of the display blocks corresponds to one of the backlight blocks.

12. The scan-backlight LCD as claimed in claim 9, wherein the time point for turning on the backlight blocks is later than the time point for driving the display blocks by a liquid crystal charging period.

13. The scan-backlight LCD as claimed in claim 9, wherein the gate sequence signal comprises several bits, and a code formed by the bits represents the first sequence of the display blocks.

14. The scan-backlight LCD as claimed in claim 9, wherein each of the gate driver groups has an address code, and one of the gate driver groups operates when its address code appears in the gate sequence signal.

15. The scan-backlight LCD as claimed in claim 13, wherein the driving sequence of the display blocks is adjusted by altering an appearance sequence of the address code of the gate driver groups in the gate sequence signal.

16. The scan-backlight LCD as claimed in claim 9, wherein the backlight sequence signal comprises several bits, and a code formed from the bits represents the second sequence.

17. The scan-backlight LCD as claimed in claim 16, wherein the backlight sequence signal further represents a period of turning on each of the backlight blocks.

18. The scan-backlight LCD as claimed in claim 9, wherein the backlight sequence signal is used to designate the time point of turning on and the time point of turning off each of the backlight blocks.
